(19) United States
(12) Patent Application Publication
(10) Pub. No.: US 2013/0220709 A1
(43) Pub. Date: Aug. 29, 2013

(54) SYSTEM AND METHOD FOR WEIGHING VEHICLES IN MOTION

(71) Applicant: SHEKEL SCALES (2008) LTD., (US)

(72) Inventor: Michael TRAKHIMOVICH, Gan Ner (IL)

(73) Assignee: SHEKEL SCALES (2008) LTD., Kibbutz Beit-Keshet (IL)

(21) Appl. No.: 13/741,409

(22) Filed: Jan. 15, 2013

Related U.S. Application Data
(63) Continuation-in-part of application No. PCT/IB2011/001657, filed on Jan. 26, 2012.

(51) Int. Cl. G01G 19/02

(52) U.S. Cl. CPC G01G 19/024
USPC 177/134

(57) ABSTRACT

A WIM system and method for weighing a moving vehicle on a roadway, the system including: (a) a base for anchoring to a roadbed; (b) a weighing platform mounted on the base and adapted to receive the wheel of the vehicle along a longitudinal axis of the platform, the platform having a length within a range of 0.5 to 1.90 meters along the axis; (c) a load cell disposed between the base and platform, and adapted to provide vertical load signals indicating vertical loads applied by the wheel on the platform; (d) a longitudinal differentiation mechanism, mechanically associated with the platform and the base.

### CROSS-REFERENCE TO RELATED APPLICATIONS

This application is a Continuation in Part (CIP) of PCT Application No. PCT/IB2011/001657, filed Jul. 17, 2011, which draws priority from U.S. Provisional Patent Application Ser. No. 61/365,323, filed Jul. 17, 2010, both of which are hereby incorporated by reference for all purposes as if fully set forth herein.

### FIELD AND BACKGROUND OF THE INVENTION

The present invention relates to weighing systems and, more particularly, to weighing apparatus, systems and methods for weighing vehicles in motion.

Weigh-in-motion (WIM) devices are designed to capture and record vehicle (typically truck) or axle weights and gross vehicle weights as they drive over a sensor. Gross vehicle and axle weight monitoring is useful in an array of applications including the design, monitoring, and research of pavements and bridges, as well as weight enforcement on roads and highways.

The ability to weigh vehicles in motion offers many advantages over static weighing. Processing rates increase because trucks can be weighed as they travel at highway speeds, resulting in a significantly greater number of counted vehicles in a shorter period of time, as compared to conventional, static weight stations. In addition, the minimization of static weighing will significantly decrease vehicle accumulation at highway lanes leading to weight stations, improving safety in addition to efficiency.

An additional advantage of WIM is that truck traffic is monitored without alerting truck drivers. Truck operators may go to considerable lengths to avoid a weigh station for various reasons. This avoidance reduces the amount of data available to regulatory authorities as to truck traffic and also places heavy trucks on roads not designed for such traffic.

A WIM system may typically include a base anchored in concrete beneath the surface of the roadway, a weighing platform preferably disposed in a substantially level fashion with respect to the surface of the roadway, and load cells, mounted between the platform and the base, adapted to provide a signal indicating the load applied by the wheel contacting the platform.

As the wheel of a vehicle contacts the weighing platform it applies forces in the horizontal direction in addition to the vertical direction. The horizontal deflection affects the accuracy of the load cell. A typical way to solve this problem is to limit relative movement in the horizontal direction by inserting a stiff arm or flexure between the platform and the base in order to resist horizontal forces while remaining weakly resistant to vertical forces. Such a system is disclosed in U.S. Pat. No. 4,957,178 to Mills et al., which is hereby incorporated in its entirety by reference for all purposes, as if fully set forth herein.

This solution, however, limits freedom in the vertical direction enough to be highly inaccurate relative to static scales. According to the National Bureau of Standards, wheel load scales are required to have an accuracy of ±1% when tested for certification and must be maintained thereafter at ±2%. To the best of the present inventor's knowledge, the best accuracy obtained with the most expensive, commonly used WIM devices may be around 6% of actual vehicle weights, with a probability of approximately 0.95.

The present inventor has recognized a need for improved methods, apparatus, and systems for weighing vehicles in motion, and the subject matter of the present disclosure and claims is aimed at fulfilling this need.

### SUMMARY OF THE INVENTION

According to the teachings of the present invention there is provided a weigh-in-motion system for accurately determining a weight of a moving vehicle on a roadway by measurement of vertical forces compensated by horizontal forces applied by a wheel of the vehicle to a weighing platform, the system including: (a) a base adapted to be anchored to a roadbed of the roadway; (b) a weighing platform mounted on the base and adapted to receive the wheel of the moving vehicle along a longitudinal axis of the platform, the platform having a length of at least 0.5 meters along the axis; (c) at least one load cell disposed between the base and the platform, and adapted to provide vertical load signals indicating vertical loads applied by the wheel on the platform; (d) a longitudinal differentiation mechanism, mechanically associated with the platform and the base, the longitudinal differentiation mechanism including: (i) a mechanical resistance-measuring unit adapted to provide a resistance to a relative horizontal movement between the base and the platform, the movement generally along the longitudinal axis, to differentiate horizontal forces produced by the wheel acting on the platform, and (ii) a measuring unit, associated with the resistance-measuring mechanical unit, the measuring unit adapted to make a measurement of a parameter associated with the resistance to the relative horizontal movement, and to produce an output signal relating to the measurement, and (e) a processing unit configured to: (i) receive the vertical load signals from the at least one load cell, and the output signal from the measuring unit, and (ii) measure a weight of the wheel on the platform by effecting a compensation for error in the vertical load signals with the output signal from the measuring unit, to produce a corrected weight signal.

According to another aspect of the present invention there is provided a method of accurately determining a weight of a moving vehicle on a roadway by measurement of vertical forces compensated by horizontal forces applied by a wheel of a vehicle to a weighing platform, the method including the steps of: (a) providing a system including: (i) a base anchored to a roadbed of the roadway; (ii) a weighing platform mounted on the base and adapted to receive the wheel of the moving vehicle along a longitudinal axis of the platform, the platform having a length of at least 0.5 meters along the axis; (iii) at least one load cell disposed between the base and the platform, and adapted to provide load signals indicating loads applied by the wheel on the platform; (iv) a longitudinal differentiation mechanism, mechanically associated with the platform and the base, the longitudinal differentiation mechanism including: (A) a mechanical unit adapted to provide a resistance to a relative horizontal movement between the base and the platform, the movement generally along the longitudinal axis, to differentiate horizontal forces produced by the wheel acting on the platform, and (B) a measuring unit, associated with the mechanical unit, the measuring unit adapted to make a measurement of a parameter associated with the resistance and to produce an output signal relating to the measurement, and (v) a processing unit configured to: (A) receive the vertical load signals from the at least one load cell, and the output signal from the measuring unit, and (B) measure a weight of the wheel on the platform by effecting a compensation for error in the vertical load signals with the output signal from the measuring unit, to produce a corrected weight signal; (b) moving at least one wheel of a vehicle along the longitudinal axis of the platform to provide the load signals and to produce the relative horizontal movement; (c) producing the output signal containing the measurement; and (d) compensating for the error in the vertical load signals with the output signal from the measuring unit to produce a corrected weight signal.

According to further features in the described preferred embodiments, the at least one load cell includes at least two load cells, at least three load cells, or at least four load cells.

According to still further features in the described preferred embodiments, the measurement of the parameter is a plurality of measurements over a period in which the wheel is disposed on the platform.

According to still further features in the described preferred embodiments, at least one of the measuring unit and the processing unit is further configured to exclude from the compensation for error in the vertical load signals, at least one of an initial data spike and a final data spike in the output signal.

According to still further features in the described preferred embodiments, at least one of the measuring unit and the processing unit is further configured to exclude from the compensation for error in the vertical load signals, both an initial data spike and a final data spike in the output signal.

According to still further features in the described preferred embodiments, the measurement of the parameter is a plurality of measurements over a particular time interval, and wherein at least one of the measuring unit and the processing unit is further configured to exclude, from the compensation for error in the vertical load signals, the output signal produced during at least one of an initial period and a final period of the interval, or during both an initial period and a final period of the interval.

According to still further features in the described preferred embodiments, the measurement of the parameter is a plurality of measurements over a particular time interval, and wherein the processing unit is further configured to define a measurement window based on at least one pre-determined rule, and to solely utilize the output signal produced during the measurement window, in effecting the compensation for error in the vertical load signals.

According to still further features in the described preferred embodiments, the system further includes a restoration mechanism, mechanically associated with the platform, the restoration mechanism adapted to repeatably restore the platform to a particular position.

According to still further features in the described preferred embodiments, the system further includes a restoration mechanism, mechanically associated with the platform, the restoration mechanism adapted to repeatably and reversibly restore the platform to a particular position, within 0.5 seconds, within 0.3 seconds, or within 0.15 seconds.

According to still further features in the described preferred embodiments, the mechanical unit includes a spring, disposed to extend and contract in a plane parallel with respect to a weighing surface of the weighing platform.

According to still further features in the described preferred embodiments, the mechanical unit includes a hydraulic arm disposed and adapted to provide the resistance to the relative horizontal movement.

According to still further features in the described preferred embodiments, the mechanical unit includes a pneumatic arm disposed and adapted to provide the resistance to the relative horizontal movement.

According to still further features in the described preferred embodiments, the mechanical unit includes a spring disposed and adapted to provide the resistance to the relative horizontal movement.

According to still further features in the described preferred embodiments, the measuring unit is adapted to measure a change in length associated with the relative horizontal movement.

According to still further features in the described preferred embodiments, the measuring unit includes an extensometer.

According to still further features in the described preferred embodiments, the extensometer includes a mechanical extensometer.

According to still further features in the described preferred embodiments, the mechanical extensometer includes an electrical transducer.

According to still further features in the described preferred embodiments, the electrical transducer includes a strain-gauge device.

According to still further features in the described preferred embodiments, the electrical transducer includes a linear variable differential transformer sensor.

According to still further features in the described preferred embodiments, the mechanical unit includes a spring adapted to provide the measurable resistance to the relative horizontal movement.

According to still further features in the described preferred embodiments, the load cell includes a mechanical strain gauge.

According to still further features in the described preferred embodiments, the system further includes the roadway and the roadbed.

According to still further features in the described preferred embodiments, a top weighing surface of the platform forms a part of a top surface of the roadway.

According to still further features in the described preferred embodiments, the platform is angularly positioned away from a normal position with respect to a longitudinal direction of the roadway.

According to still further features in the described preferred embodiments, the platform is angularly installed in the roadway whereby an angle of rotation α, with respect to the normal position, equals at least 5°, at least 6°, at least 7°, or at least 8°.

According to still further features in the described preferred embodiments, the angle of rotation α equals at most 25°, at most 20°, at most 18°, or at most 15° degrees.

According to still further features in the described preferred embodiments, a shape of the platform is a non-rectangular parallelogram.

According to still further features in the described preferred embodiments, the restoration mechanism includes a rocker.

According to still further features in the described preferred embodiments, the rocker has a conical body.

According to still further features in the described preferred embodiments, at least a portion of the secondary restoration mechanism is disposed around the rocker.

According to still further features in the described preferred embodiments, the secondary restoration mechanism includes a pre-stressed membrane disposed around the rocker.

According to still further features in the described preferred embodiments, the at least one load cell includes at most eight load cells, at most six load cells, or at most five load cells.

According to still further features in the described preferred embodiments, the at least one load cell is adapted to be calibrated by a static load. The static load may be a substantially solely vertical static load, having substantially no horizontal component.

According to still further features in the described preferred embodiments, the base is substantially parallel to a top or weighing surface of the weighing platform.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a simplified, schematic view of a WIM system according to a first aspect of the present invention;

FIG. 2a is a logical flow diagram according to one aspect of the method of the present invention;

FIG. 2b is a logical flow diagram according to another aspect of the inventive method;

FIG. 3 is a simplified, schematic view of a WIM system according to an embodiment of the present invention;

FIG. 4 is a schematic exemplary exploded view of a weighing module according to an embodiment of the present invention;

FIG. 5 is a perspective view of a flexure attached between top and bottom elements of the weighing module;

FIG. 5a shows a horizontal displacement of the flexure of FIG. 5;

FIG. 5b shows a vertical displacement of the flexure of FIG. 5;

FIG. 6 is a schematic exemplary embodiment of a rocker mechanism of the present invention;

FIG. 7 is a top, schematic view of a weighing platform according to an embodiment of the present invention; and

FIG. 8 is a plot of vertical and horizontal forces as a function of time, for a wheel rolling on to, and off of, an apparatus of the present invention.

### DESCRIPTION OF THE PREFERRED EMBODIMENTS

The principles and operation of the weigh-in-motion (WIM) system and method of the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

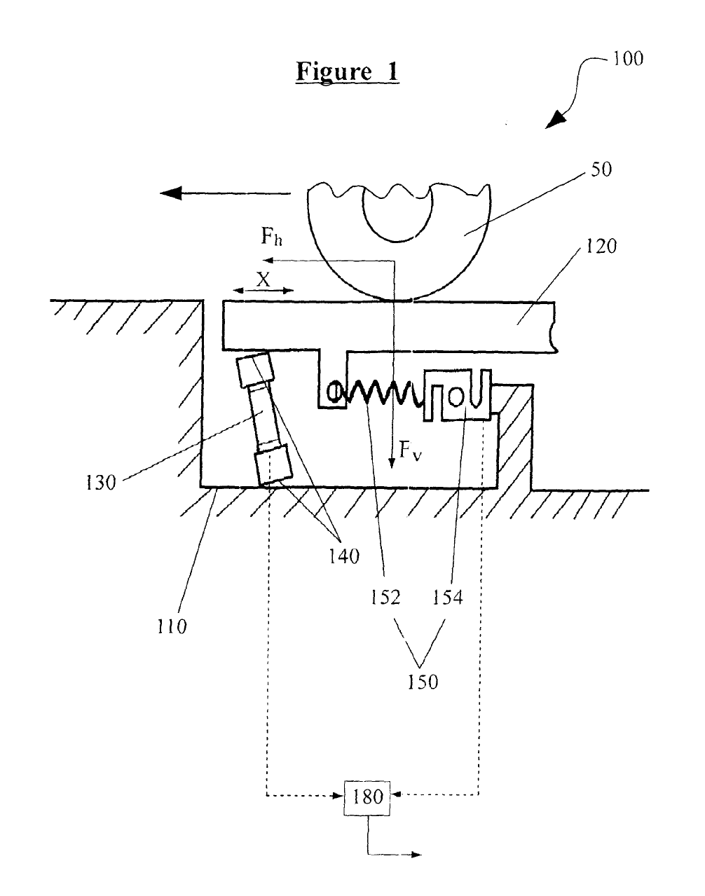

Referring now to the drawings, FIG. 1 is a simplified, schematic view of a WIM system 100 according to the present invention. WIM system 100 includes a base 110 adapted to attach or anchor to a roadbed, a weighing platform 120 mounted on the base and adapted to receive wheels of moving vehicles such as motor vehicle wheel 50 along a longitudinal axis X of the platform, and at least one load cell 130 disposed between the base and the platform, and adapted to provide load signals indicating loads applied by the wheels on the platform. WIM system 100 also includes a longitudinal differentiation mechanism 150, mechanically associated with the platform and the base. This mechanism may include a mechanical resistance unit (element or assembly) 152 adapted to provide a measurable resistance to a relative horizontal movement between the base and the platform, the movement generally along longitudinal axis X, to differentiate horizontal forces produced by the wheels acting on the platform, and a measuring unit 154, associated with the mechanical unit, and adapted to make a measurement of a parameter associated with the resistance and to produce an output signal relating to the measurement.

Mechanical resistance unit (element or assembly) 152 may include a spring such as a cylindrical or spiral spring, a hydraulic arm a pneumatic arm, or other mechanical resistance unit adapted to measurably resist the relative horizontal movement between the base and the platform. As used herein in the specification and in the claims section that follows, the term “measurably resist”, “measurable resistance”, and the like is meant to refer to a resistance that is repeatable in a manner that enables meaningful measurement of the resistance, so as to enable analysis of the resistance.

Measuring unit 154 may include an extensometer. An extensometer is an instrument for measuring changes in length that are caused by application of force. Various types of extensometers are known. Changes in length may be measured directly by some types of devices, such as clip-on extensometers, or indirectly by non-contact or video extensometers.

Mechanical or contact-type extensometers may use electrical transducers such as linear variable differential transformer (LVDT) sensors or strain-gauge devices (and sometimes combinations of the two) to generate an electrical signal proportional to change in length or strain. An extensometer system may also incorporate electronics for amplification of small signals.

WIM system 100 also includes a processing unit or processor 180, such as a central processing unit (CPU). Processor 180 may be configured to receive the load signals from the at least one load cell and the output signal from the measuring unit, and to produce a weight indication based on the load signals and the output signal from the measuring unit.

WIM system 100 is preferably equipped with a restoration mechanism such as restoration mechanism 140, which serves to restore a position of weighing platform 120 with respect to base 110, in preparation for another wheel rolling on to weighing platform 120. In WIM system 100, load cell 130 is a column-type load cell, and restoration mechanism 140 includes cupped surfaces on the top and on the bottom of load cell 130.

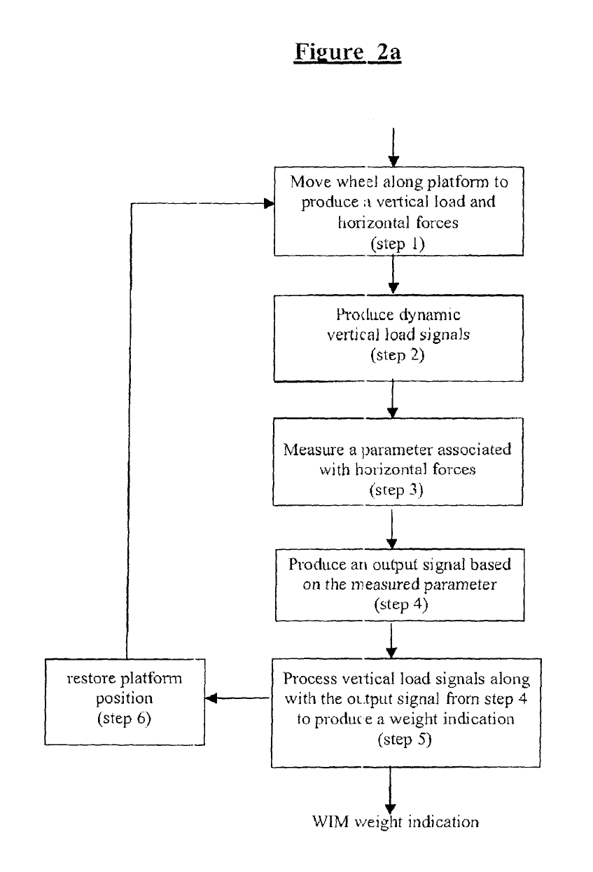

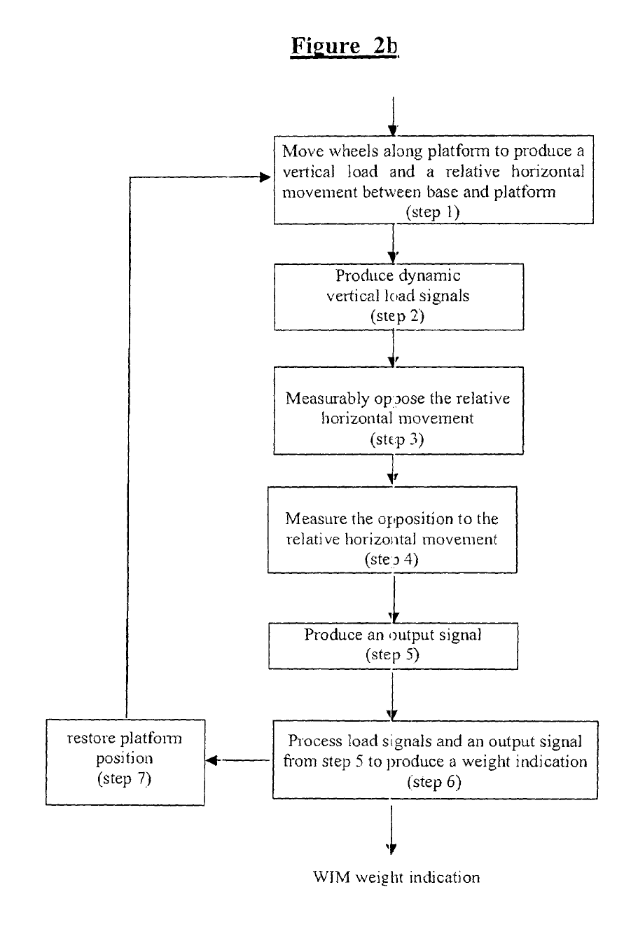

One aspect of the method of the present invention will now be described, with reference to the logical flow diagram provided in FIG. 2a. A wheel such as motor vehicle wheel 50 is enabled to roll along a longitudinal axis of platform 120 to produce a dynamic vertical load as well as longitudinal horizontal forces exerted on platform 120 (step 1). The vertical load acts upon at least one load cell such as load cell 130, which produces dynamic vertical load signals corresponding to, or associated with, the vertical load (step 2).

WIM system 100 may also measure a parameter (step 3) associated with these horizontal forces, and produce an output signal based on, or related to, this measured parameter (step 4).

In step 5, a processing unit such as processor 180 processes the vertical load signals along with the output signal from step 4 to produce a WIM weight indication. A restoration mechanism such as restoration mechanism 140, which serves to restore a position of weighing platform 120 with respect to base 110, may be activated (step 6) in preparation for another wheel rolling on to weighing platform 120.

Another aspect of the method of the present invention will now be described, with reference to the logical flow diagram provided in FIG. 2b. A WIM system such as WIM system 100 is provided. Subsequently, a wheel such as motor vehicle wheel 50 is enabled to rotate along a longitudinal axis of platform 120 to produce a dynamic vertical load and load signals corresponding thereto, and to produce a relative horizontal movement between base 110 and platform 120 (step 2). The vertical load acts upon at least one load cell such as load cell 130, which produces load signals corresponding to the vertical load.

WIM system 100 includes a longitudinal differentiation mechanism, such as longitudinal differentiation mechanism 150 described hereinabove. A mechanical unit (element or assembly) thereof, such as mechanical unit 152, provides a measurable resistance to the relative horizontal movement between base 110 and platform 120, generally along longitudinal axis X of platform 120, to longitudinally differentiate horizontal forces produced by wheel 50 acting on platform 120 (step 3).

A measuring unit (element or assembly), associated with mechanical unit 152, such as measuring unit 154, makes a measurement of a parameter associated with this measurable resistance and produces an output signal relating to this measurement (steps 4, 5).

In step 6, a processing unit such as processor 180 processes the vertical load signals along with the output signal from step 4 to produce a WIM weight indication. A restoration mechanism such as restoration mechanism 140, which serves to restore a position of weighing platform 120 with respect to base 110, may be activated (step 7) in preparation for another wheel rolling on to weighing platform 120.

One of ordinary skill in the art may readily appreciate that there are various ways of calibrating, correlating or transforming the output signal (e.g., that of step 5 in FIG. 2b) into a vertical weight or into a vertical weight correction term. By way of example, the stationary weight of a truck wheel or axle may be measured on the weighing platform. Additional measurements may be made in which the dynamic weight of the truck wheel or axle may be measured on the weighing platform at constant speeds of 1 kilometer per hour (kph), 2 kph, 3 kph, 5 kph, 10 kph, 25 kph, 50 kph, 75 kph, 100 kph, and 125 kph. Since the stationary weight of the truck wheel or axle is known, the measured horizontal forces or opposition to the horizontal movement may be correlated with vertical weight, or with the stationary weight less the dynamic vertical weight. A curve may then be fitted to the data to obtain the vertical weight correction term (or magnitude) as a function of the measured horizontal forces or opposition to the horizontal movement. With such a relationship in place, the inventive weighing apparatus, weighing systems and methods for weighing vehicles in motion may be utilized.

Thus, in practice, a truck wheel or axle engaging the weighing platform will produce a dynamic vertical weight along with measured horizontal forces or a measured opposition to the horizontal movement between the weighing platform and weighing base. The measure horizontal term may be converted to a vertical weight correction term, which may be added to correct or improve the value of the dynamic vertical weight, whereby the corrected vertical weight may closely approach or more closely approach the actual stationary weight of the truck wheel or axle.

As used herein in the specification and in the claims section that follows, the term “extensometer” refers to an instrument for measuring a longitudinal displacement or extension caused by an application of force.

Mechanical resistance unit (element or assembly) 152 may include a spring or other resistance units that, at least ideally, approach the behavior delineated by Hooke's law. In the ideal case, the extension produced is directly proportional to the load:

F=−k·x

wherein:

F is the restoring force exerted by the material, and

k is the spring constant (in units of force per unit length).

Thus, for systems in which the extension produced is well correlated (using Hooke's law or any other correlation) with the load—in this case, horizontal forces—accurate measurement of the extension of mechanical resistance unit 152 may, in turn, enable accurate computation of the load.

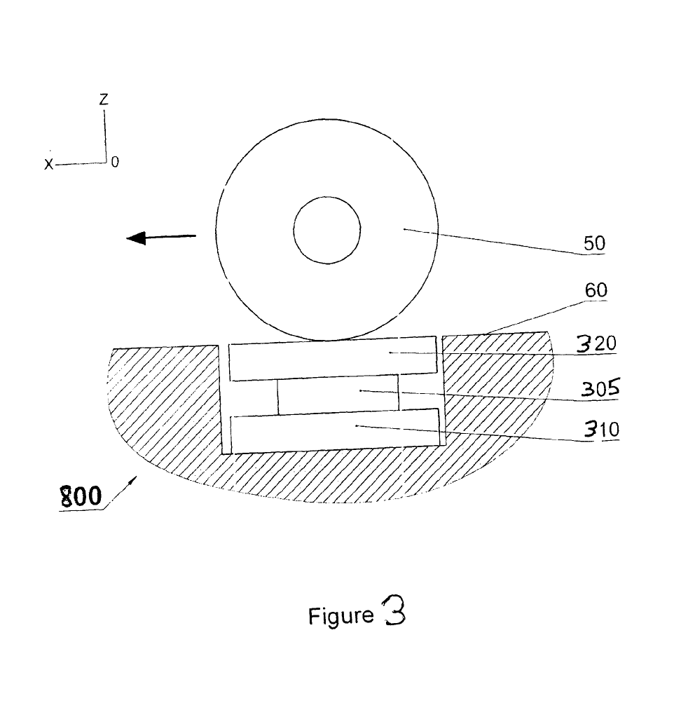

Referring now to FIG. 3, FIG. 3 is a simplified, schematic view of a WIM system 800 according to the present invention. WIM system 800 includes a base 310 for anchoring to a roadbed 60, a weighing platform 320 adapted to receive wheels of moving vehicles such as motor vehicle wheel 50 along a longitudinal axis X of the platform, and at least one weighing module 305 disposed between the base and the platform, and adapted to provide load signals indicating loads applied by the wheels on the platform. Weighing module 305 may include a longitudinal differentiation mechanism such as longitudinal differentiation mechanism 150 described hereinabove.

In one embodiment, WIM system 800 may be adapted to simultaneously receive both wheels (or all wheels) of a single vehicle axle. In another embodiment, the weighing system may include two or more separate parallel weighing platforms 320 installed in roadway 60, each adapted to receive a single wheel 50 (or in the case of double wheels—a double wheel on a single side) of a vehicle axle.

I believe that it is highly preferable for the weighing platforms to be of sufficient length so as to fully support motor vehicle wheel 50. This is in sharp contrast to various strips or cables of the prior art, which receive—at most—a fraction of the weight exerted by wheel 50, the remainder of the weight being supported by the roadway itself.

Thus, the weighing platform of the present information (such as platforms 120, 320 described hereinabove) may typically have a length of at least 0.50 meters, at least 0.60 meters, at least 0.70 meters, at least 0.80 meters, or at least 0.90 meters.

It may be advantageous for the weighing platform of the present information to enable solely a single wheel or wheels from a single axis to be disposed on the platform at any particular time. Thus, the weighing platform of the present information (such as platforms 120, 320 described hereinabove) may typically have a length of at most 2.50 meters, at most 2.30 meters, at most 2.20 meters, at most 2.00 meters, at most 1.90 meters, at most 1.70 meters, at most 1.50 meters, at most 1.30 meters, at most 1.10 meters, at most 1.00 meter, or at most 0.90 meters.

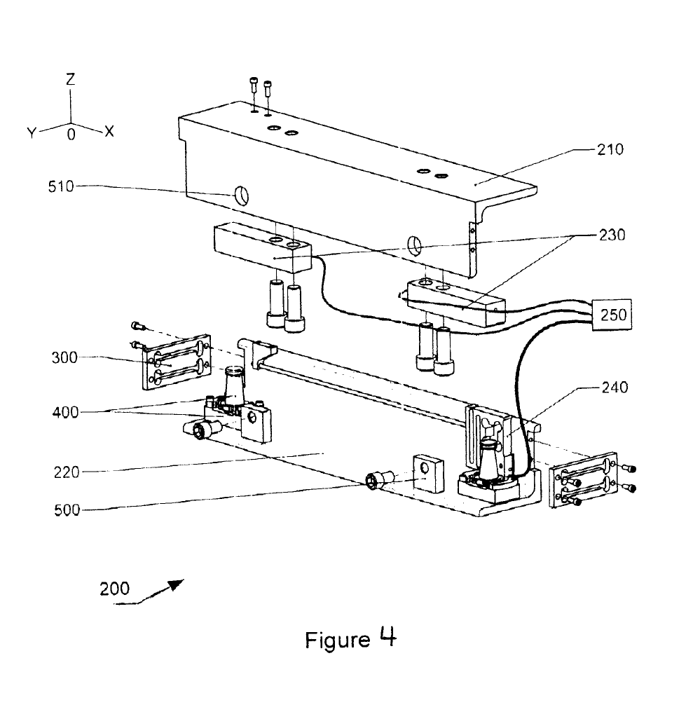

The schematic, exemplary embodiment of a weighing module 200, provided in FIG. 4, includes a top element 210 adapted to attach to weighing platform 320 (shown in FIG. 3), a bottom element 220 adapted to attach to a base 310 (such as shown in FIG. 3), at least one load cell such as load cells 230, which may be attached to top element 210, a measuring unit 240 adapted to measure horizontal displacement or forces of top element 210 with respect to bottom element 220, and a processor 250 that may be adapted to receive signals from load cells 230 and from measuring unit 240.

Weighing module 200 may further include an overload protector 500, adapted to protect weighing module 200 against excess horizontal forces, a restoration mechanism including rocker mechanism 400 for each load cell 230, and a flexure 300 connecting between top element 210 and bottom element 220. Flexure 300 may serve as part of the restoration mechanism.

The horizontal measurement obtained by measuring unit 240 may be used to correct the vertical load cell measurement obtained by load cells 230. Processor 250 may process the received signals, correct for horizontal displacement, and determine the weight of wheel 50 on weighing platform 120.

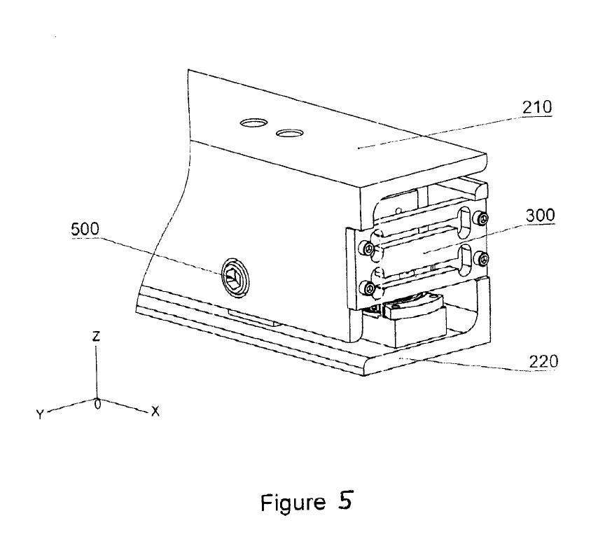

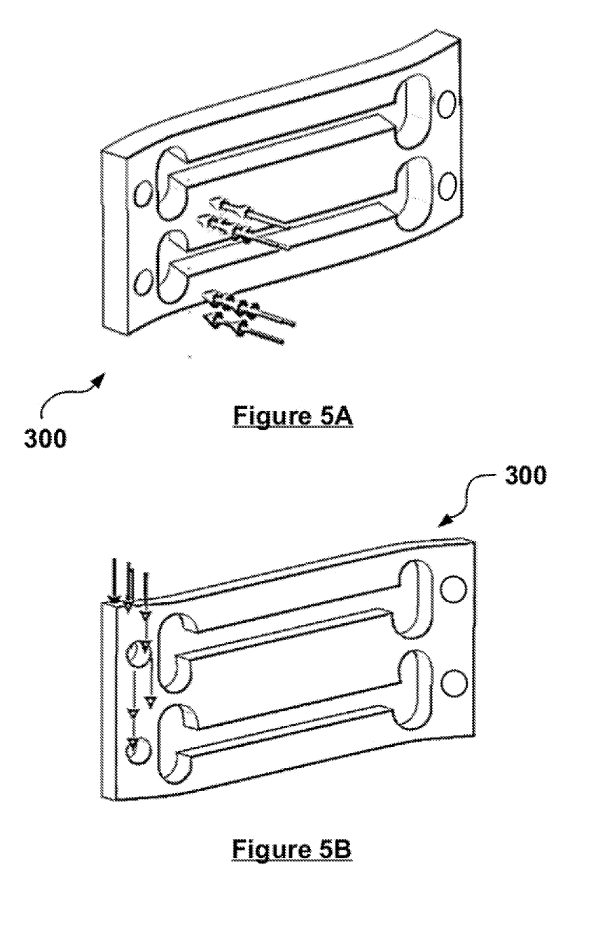

FIG. 5 is a schematic diagram of flexure 300 attached between top element 210 and bottom element 220. In order that the horizontal measurement obtained by measuring unit 240 (shown in FIG. 4) is affected only by horizontal displacement and not vertical displacement, flexure 300 may be designed to achieve double bending, whereby vertical movements are resisted. Flexure 300 may be further adapted to resist horizontal movement in directions other than parallel to the longitudinal axis of weighing platform 120.

FIG. 5a shows a horizontal displacement of flexure 300. FIG. 5b shows a vertical displacement of flexure 300. I found experimentally that it may be preferable for flexure 300 to be preloaded by at least 5% or at least 10% of the platform weight capacity. The preloading of flexure 300 is typically below 50%, more typically between 10-40%, between 10-30%, or between 10-25% of platform weight capacity. Some aspects of the restoration mechanism will be described in greater detail hereinbelow.

Referring again to the schematic exemplary embodiment in FIG. 4, excessive horizontal forces may be stopped by at least one overload protector 500, which is typically attached to bottom element 220 and which may fit inside an opening or recess 510 in top element 210. Vehicles that brake suddenly while approaching the weighing platform may exert excessive horizontal forces on the WIM system, which may break system parts or cause inaccurate weight readings. When disposed in opening 510, protector 500 blocks the horizontal forces exerted by top element 210.

I have discovered that in imparting the desired horizontal flexibility to the WIM system of the present invention, severe problems may occur in restoring the initial horizontal position of weighing platform (such as weighing platforms 120, 320 described hereinabove), which may yield inaccurate and non-repeatable results. In order to correct this problem, a restoration mechanism including rocker mechanism 400 may be advantageously disposed between load cell 230 and bottom element 220.

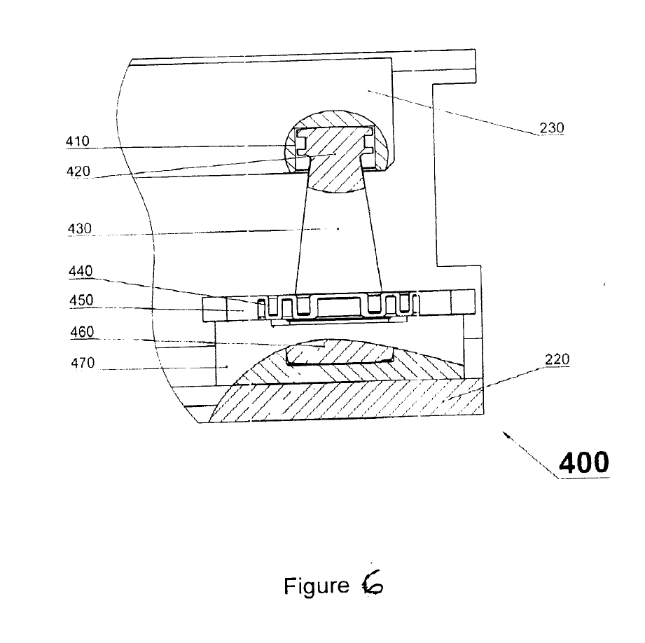

FIG. 6 is a schematic exemplary embodiment of rocker mechanism 400. A rocker 430, which may be generally conical, may include a rocker head 420 and a spherical base 460. Rocker head 420 may be adapted to fit into a depression 410 on a bottom side of load cell 230. Spherical base 460 of rocker 430 may sit in a spherical or rounded receiving base 470 attached to bottom element 220. Rocker head 420 and spherical base 460 are designed to act, together with flexure 300 (shown in FIG. 5 and described hereinabove), as a restoration mechanism.

Referring now to FIGS. 3-6, it will be appreciated by one of ordinary skill of the art that when vehicle wheel 50 rolls onto weighing platform 320, weighing platform 320 is urged forward by a measurable longitudinal displacement X in the direction of travel. Top element 210, load cell 230, and top of rocker 430 move together with weighing platform 320, while the bottom of rocker 430 rocks within receiving base 470 without moving horizontally forward. After wheel 50 leaves weighing platform 320, horizontal forces due to the tire abate, and rocker 430 moves back to its initial position.

Because of horizontal flexibility inherent in the WIM system of the present invention, I have further found that various conventional sphere or rocker mechanisms may not restore the position of the elements fast enough, especially when measuring loads from multiple axes of trucks traveling at high speeds. Moreover, conventional sphere or rocker mechanisms may compromise the accuracy of measurement as horizontal forces on the sphere or rocker may be translated into vertical forces applied against top element 210.

Referring again to the schematic exemplary embodiment in FIG. 6, a secondary restoration mechanism may include a pre-stressed membrane 440 adapted to fit over conical body of rocker 430. Membrane 440 is attached to receiving base 470 to prevent vertical displacement in rocker 430. Membrane 440 behaves like a spring in the horizontal direction due to grooves like exemplary groove 450, which gives membrane 440 spring-like properties and measurable displacement in the horizontal direction. Membrane 440 returns rocker mechanism 400 whereby top element 210 and bottom element 220 may vertically realign in their initial position, faster and with more precision than conventional sphere or rocker mechanisms.

I have further found that under high-speed conditions, wheels rolling onto weighing platform may produce sudden horizontal forces, thereby increasing the noise component of both the horizontal and vertical displacement measurements. This noise component causes inaccurate load calculations of the partial vehicle load on the wheel. One solution is to lengthen weighing platform, but this significantly raises the cost of the system, both in parts and installation. Moreover, the natural frequency is lowered, thereby increasing oscillation and reducing weighing precision. Also, the length of the platform may be limited to a length allowing the wheel or wheels of a single axle to be disposed on the platform at any given time.

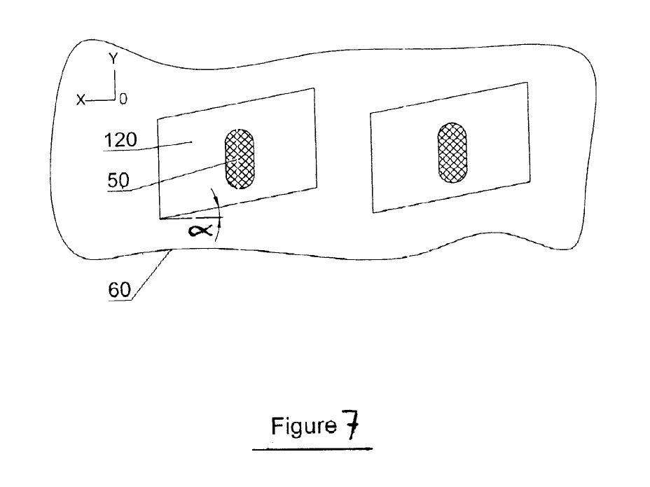

My inventive solution to this problem is shown in the top, schematic view provided in FIG. 7. The weighing platform such as weighing platform 120 may advantageously be installed in roadway 60 whereby an angle of rotation α (with respect to a direction perpendicular to roadway 60) preferably equals at least 6°, at least 7°, or at least 8°, and preferably equals less than 25°, less than 20°, less than 18°, or less than 15° degrees. Under these conditions, wheel 50 may alight gradually on to, and off of, weighing platform 120. As a result, noise related to force measurements in the horizontal direction is greatly reduced, thereby increasing accuracy in measurements and subsequent load calculations.

As discussed hereinabove, existing WIM axle-weighing systems may be characterized by low accuracy (+/−15-20%) compounded by a finite (non-unity) probability (typically 80%-95%) of achieving that accuracy. I have found that the amplitude/intensity of horizontal forces is a strong indication of the accuracy of the associated weight measurement. When the amplitude/intensity of horizontal forces is low, the accuracy of the associated weight measurement is high, and vice versa.

Thus, by measuring horizontal forces (and processing them), the quality of an associated weight measurement may be indicated, without effecting a compensation for error in the vertical load signals. By way of example, based on a particular measurement of horizontal forces, the inventive method may determine that a particular weight measurement is within 7% of the true (static) value, with a certainty approaching 100% (as opposed to the 80%-95% achieved in various prior-art technologies). Alternatively or additionally, the inventive method may be used to determine, with the same 80%-95% certainty achieved by prior-art technologies, that a particular weight measurement is within only 2% of the true value.

Theoretically, a horizontal behavior measuring system could be retrofitted to various existing, prior-art WIM systems, in order to improve the certainty of the weight measurements, and/or to identify particular weight measurements having a particularly high or pre-determined accuracy.

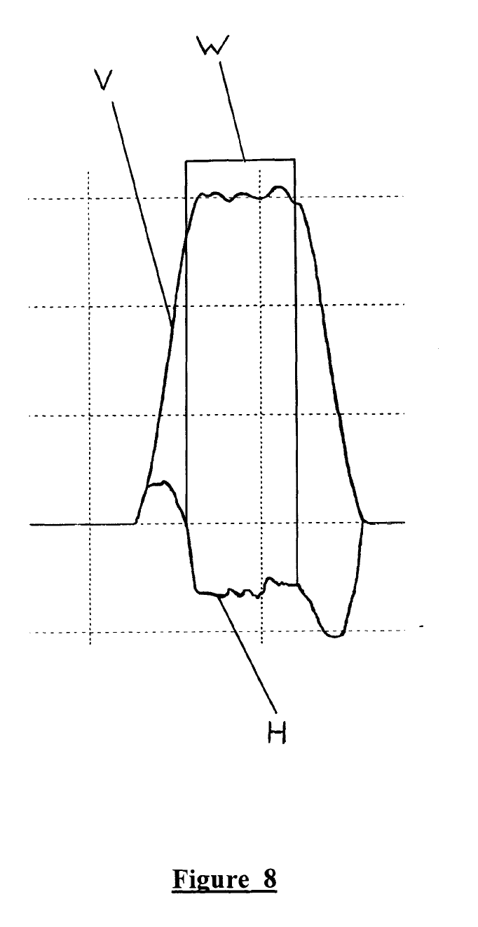

FIG. 8 is a plot of the vertical force signal F, and the horizontal force signal H, as a function of time, for a wheel rolling on to, and off of, an apparatus of the present invention. As the wheel rolls on to the weighing platform, the load cells begin to receive a portion of the load of the wheel. When the wheel solely contacts the weighing platform (and is not partially supported by the roadway), the load on the load cells substantially plateaus. As the wheel gradually rolls off the weighing platform, the load cells receive a decreasing portion of the load of the wheel, until the wheel is completely supported by the roadway.

It is important to emphasize that even within the plateau region of the plot, the vertical force signal F is not constant. Moreover, the average value may be appreciably different from the static (real) weight exerted by the wheel.

With reference now to the plot of the horizontal force signal H as a function of time, the scale of the Y-axis has been magnified in order to better view the details of the plot. This plot reveals a (positive) spike during the initial time period in which the wheel rolls on to the weighing platform, and an additional, negative spike during the final or end period in which the wheel rolls off to the weighing platform.

Techniques for identifying such spikes are readily available to those of ordinary skill in the art of signal processing. Such techniques may include identifying peaks having a slope above a pre-determined value; identifying peaks having a slope above a pre-determined value and a magnitude, with respect to the magnitude thereafter (for an initial spike) or therebefore (for an end spike). A measurement window may be identified in the time period between the initial and end spikes.

In one embodiment of the present invention, the processor processes the vertical load signal along with the horizontal force signal to produce a WIM weight indication. The WIM weight indication may be an average weight indication, e.g., taken over a period of time in which the load on the vertical load cells has substantially plateaued.

Determining the plateau width and absolute load will be readily apparent to one of ordinary skill in the art of signal processing.

In another embodiment of the present invention, the processor processes the horizontal force signal and may identify at least one time period containing a spike (or other disturbance-related phenomenon). The processor is further adapted to exclude the disturbed time period(s) from a sampling time window W, which is illustratively shown in FIG. 8. The vertical force signal F may then be processed solely within sampling time window W.

As used herein in the specification and in the claims section that follows, the term “mechanical resistance-measuring unit” is meant to include a mechanical resistance-measuring element or a mechanical resistance-measuring assembly.

As used herein in the specification and in the claims section that follows, the term “horizontal movement” and the like is meant to refer to a movement that is horizontal with respect to the weighing surface of the weighing platform.

As used herein in the specification and in the claims section that follows, the term “adapted to be calibrated by a static load” and the like, with respect to a load cell, is meant to exclude piezoelectric elements and other elements that require dynamic calibration, or which calibrate poorly under static load conditions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. No. 4,957,178, are herein incorporated in their entirety by reference into the specification, to the same extent as if each individual publication, patent or patent application was specifically and individually indicated to be incorporated herein by reference.

What is claimed is:

1. A weigh-in-motion (WIM) system adapted to accurately determine a weight of a moving vehicle on a roadway by measurement of vertical forces compensated by horizontal forces applied by a wheel of the vehicle to a weighing platform, the system comprising:
(a) a base adapted to be anchored to a roadbed of the roadway;
(b) a weighing platform mounted on said base and adapted to receive the wheel of the moving vehicle along a longitudinal axis of said platform, said platform having a length of at least 0.5 meters and less than 1.9 meters along said axis;
(c) at least one load cell disposed between said base and said platform, and adapted to provide vertical load signals indicating vertical loads applied by the wheel on said platform;
(d) a longitudinal differentiation mechanism, mechanically associated with said platform and said base, said longitudinal differentiation mechanism including:
(i) a mechanical resistance-measuring unit adapted to provide a resistance to a relative horizontal movement between said base and said platform, said movement generally along said longitudinal axis, to differentiate horizontal forces produced by the wheel acting on said platform, and
(ii) a measuring unit, associated with said resistance-measuring mechanical unit, said measuring unit adapted to make a measurement of a parameter associated with said resistance to said relative horizontal movement, and to produce an output signal relating to said measurement, and
(e) a processing unit configured to:
(i) receive said vertical load signals from said at least one load cell, and said output signal from said measuring unit, and
(ii) measure a weight of said wheel on said platform by effecting a compensation for error in said vertical load signals with said output signal from said measuring unit, to produce a corrected weight signal.

2. The system of claim 1, said at least one load cell including at least two load cells.

3. The system of claim 1, said measurement of said parameter being a plurality of measurements over a period in which said wheel is disposed on said platform.

4. The system of claim 3, at least one of said measuring unit and said processing unit being further configured to exclude from said compensation for error in said vertical load signals, at least one of an initial data spike and a final data spike in said output signal.

5. The system of claim 1, said measurement of said parameter being a plurality of measurements over a particular time interval, and wherein at least one of said measuring unit and said processing unit is further configured to exclude, from said compensation for error in said vertical load signals, said output signal produced during at least one of an initial period and a final period of said interval.

6. The system of claim 1, said measurement of said parameter being a plurality of measurements over a particular time interval, and wherein said processing unit is further configured to define a measurement window based on at least one pre-determined rule, and to solely utilize said output signal produced during said measurement window, in effecting said compensation for error in said vertical load signals.

7. The system of claim 1, further comprising:
f) a restoration mechanism, mechanically associated with said platform, said restoration mechanism adapted to repeatably restore said platform to a particular position.

8. The system of claim 1, further comprising:
f) a restoration mechanism, mechanically associated with said platform, said restoration mechanism adapted to repeatably and reversibly restore said platform to a particular position, within 0.5 seconds.

9. The system of claim 1, said mechanical unit including a spring, disposed to extend and contract in a plane parallel with respect to a weighing surface of said weighing platform.

10. The system of claim 1, said mechanical unit including a resisting arm selected from the group of arms consisting of a pneumatic arm and a hydraulic arm, said resisting arm disposed and adapted to provide said resistance to said relative horizontal movement.

11. The system of claim 1, said mechanical unit including a spring disposed and adapted to provide said resistance to said relative horizontal movement.

12. The system of claim 1, said measuring unit adapted to measure a change in length associated with said relative horizontal movement.

13. The system of claim 12, said measuring unit including an extensometer.

14. The system of claim 1, further comprising the roadway and said roadbed.

15. The system of claim 14, a top weighing surface of said weighing platform disposed in a substantially horizontal position with respect to sea level.

16. The system of claim 14, said platform angularly installed in the roadway such that an angle of rotation α, with respect to a longitudinal direction of the roadway, equals at least 6°.

17. The system of claim 7, said restoration mechanism including a rocker.

18. The system of claim 17, at least a portion of said restoration mechanism being disposed around said rocker.

19. The system of claim 18, wherein said restoration mechanism includes a pre-stressed membrane disposed around said rocker.

20. The system of claim 1, wherein said at least one load cell is adapted to be calibrated by a static load having substantially no horizontal component.
